(19) United States
(12) Patent Application Publication
(10) Pub. No.: US 2006/0020546 A1
(43) Pub. Date: Jan. 26, 2006

(54) Computerized system for producing fraud-inhibiting checks and method thereof

(76) Inventor: Rudolph P. Wilkinson, Ardmore, OK (US)

Correspondence Address: WOOD, NGO & EISENBERG, PLLC, 2121 Eisenhower Ave, Suite 200, Alexandria, VA, 22314, US

(21) Appl. No.: 10/896,852

(22) Filed: Jul. 23, 2004

(51) Int. Cl. G06Q 40/00

(52) U.S. Cl. 705/43; 705/45

(57) ABSTRACT

A method and computerized system for producing fraud-inhibiting checks. The system includes a server computer, a processor with the server computer, an area of main memory for executing program code under the direction of the processor, a storage device, a bus connecting the processor and the storage device, at least one database, and program code for generating fraud-inhibiting checks stored in the storage device and executing in the main memory under the direction of the processor. The computer program allows the check issuer to enter, edit, store and retrieve payee identification data, including a digital picture of the payee. The identification data and picture can then be printed on the face of a check to help prevent fraudulent use of the check. If payee identification data is not available, the disclaimer “For deposit only: in the account of the payee” is printed on the check.

### BACKGROUND OF THE INVENTION

1. Field of the Invention

The present invention relates generally to check fraud prevention and particularly to a computerized method of producing fraud-inhibiting checks which display identifying information about the payee, or, if such information is unavailable, display the words “For deposit only: in the account of the payee.”

2. Description of the Related Art

Check fraud is a multi-billion dollar problem in the financial services industry. This problem has been prevalent since checks were first used to transact business. The use of photographic pictures for identification of a person trying to cash a check is common practice, but such measures can be overcome. The related art reveals a number of more sophisticated efforts in the area of check fraud prevention.

U.S. Patent Application Publication No. 2003/0023556 published on Jan. 30, 2003, describes checks that are provided with photographs of payees to help prevent fraud when the checks are presented for negotiation. The checks include images, which are stored on the payor's data processing system using filenames, which are uniquely associated with each payee. Personal checks are prepared using commercially available check printing software in which images are “predistorted” in a manner which insures that when the checks are ultimately printed by software which “distorts” an image, with the combined “predistortion” and “distortion” resulting in a normal image.

U.S. Patent Application Publication No. 2003/0083993 published on May 1, 2003, outlines a personal bank check given to account holders via a financial institution that will have the corresponding photo of the account holder in the upper left hand corner of the check.

U.S. Pat. No. 2,462,735 issued to Goldwater on Feb. 22, 1949, outlines the construction of a check, which includes a photograph of the payee or the signee on the check. The construction of the check is also manufactured and used substantially as cheaply as present day checks.

U.S. Pat. No. 3,048,697 issued to Cavanaugh et al. on Aug. 7, 1962, outlines a system and method for preventing the fraudulent use of negotiable instruments and other papers identifying a person. More particularly, it relates to a system and method for readily identifying the bearer or drawer of valuable instruments carrying identifying images visible only when exposed to ultraviolet radiation.

U.S. Pat. No. 3,258,277 issued to Schuster on Jun. 28, 1966, outlines a blank check and stub whereby entry is required to be made of such information as the date, payee, and amount of the check as an incidence to the writing out of the check and which safeguards against inadvertent or unauthorized use of the stub as a check and which provides for an imprint of the check in a manner to prevent alteration thereof.

U.S. Pat. No. 3,671,059 issued to Zeller on Jun. 20, 1972, outlines a checkbook detachably carrying a book of personalized blank checks each having printed thereon the name and address of the person or persons authorized to negotiate the checks, with the holder also carrying a master check printed in a manner similar to blank checks, with the name and address of the same person or persons as on the blank checks for comparison therewith, and with a picture of the authorized person or persons also printed on the master check for assistance in identification at the time of negotiation of a check.

U.S. Pat. No. 3,950,015 issued to Shrock on Apr. 13, 1976, describes the use of a negotiable instrument similar to a conventional travelers check, but is distinguishable in several important details, such as the cashing party has positive identification, and the person cashing a check is a proper payee.

U.S. Pat. No. 4,865,351 issued to Smithson et al. on Sep. 12, 1989, outlines the use of a photo check in which a photograph of a person is disposed upon a check to make quick identification of the person authorized to sign the check. A photograph-dispensing device is also provided for adhering a photograph of the person onto the check.

U.S. Pat. No. 5,075,769 issued to Allen et al. on Dec. 24, 1991, outlines the use of a video identification system for producing photo print identification cards having subject portrait, subject signature and subject related data in respective areas of the card as well as a data record including individual-specific data, an image of the subject and an image of the signature of the subject.

U.S. Pat. No. 5,181,786 issued to Hujink on Jan. 26, 1993, outlines a system and method for producing admission tickets featuring electromagnetically stored and detectable information and also visual information that, at least partly, contains identification data of the holder of the admission ticket.

U.S. Pat. No. 5,244,235 issued to Helgeson on Sep. 14, 1993, outlines the use of an article for displaying a machine readable character having a predetermined location for receiving a manually marked character and an indicia which is not machine readable formed at the predetermined location.

U.S. Pat. No. 5,505,494 issued to Belluci et al. on Apr. 9, 1996, outlines the use of an identification instrument such as a pocket-sized card that includes both human-recognizable and machine-recognizable indicia. The human-recognizable material may be any combination of photographs, graphical or textual information, with the machine-recognizable section encoding any or all of the human-recognizable areas in their entirety.

U.S. Pat. No. 5,566,981 issued to Alcordo on Oct. 22, 1996, outlines the use of a bankable apparatus or postcard bank check for sending contributions by mail without the use of any letter envelope. The postcard check carries with it the dollar value of the instrument of each of the denominations as the issuing banks may determine and as the buyer may choose for the purpose of sending money from the sender to the recipient. The postcard check is for deposit only and is withdrawable only with the use of the recipient's own bank check, making it from a donor to a recipient.

U.S. Pat. No. 5,594,226 issued to Steger on Jan. 14, 1997, outlines the use of an apparatus for automatically accessing and verifying checking account status based on information contained in a bar code printed on a check, traveler's check or money order. A bar code scanner reads the information contained in the bar code and, based on that information, determines a bank code and an account code. Based on the bank code or account code, a proper bank, traveler's check company or money order company is automatically contacted. Checking, traveler's check or money order account information is then transmitted to the proper bank, traveler's check company or money order company. A receipt is also printed with a bar code matching information on the check, traveler's check or money order.

U.S. Pat. No. 5,801,365 issued to Katz on Sep. 1, 1998, outlines the use of a method of fund raising for a non-profit organization by discounted collection on special issue checks that include collecting funds from members of the organization and depositing the funds in an account in a bank. The issuing special checks are backed by the funds to the members, who uses the checks at face value to purchase goods or services from the participating merchants with the clearing of the checks back to the bank on which they are drawn and payment on the checks to the named payee merchants at the face value minus a prearranged discount.

U.S. Pat. No. 5,863,074 issued to Wilkinson on Jan. 26, 1999, outlines a personal check that includes a substrate defined to be written on and to be transferable from a first person to a second person. The personal check includes check characterizing indicia printed on the substrate and at least three different types of identification indicia printed on the substrate such that the identification indicia are not removed from the substrate when the substrate is transferred from the first person to the second person. The identifying indicia include a picture of at least the face of the first person, an alphanumeric physical parameter identifying at least an approximate visually discernable physical characteristic of the first person and a predetermined signature of the first person.

Great Britain Patent Application No. 2,037,661 granted on Dec. 14, 1978, outlines the use of a process of printing personal bank checks with a photograph of the account holder reproduced on each check.

Great Britain Patent Application No. 2,239,423 granted on Jul. 3, 1991, outlines the use of a check or credit card bearing a plastic photograph of a client. The photograph is proportionally large to the size of the card, so as to be clearly visible and be in one piece with the check or credit card.

Great Britain Patent Application No. 2,248,209 granted on Apr. 1, 1992, outlines the use of a check, credit card or the like that includes a photograph of the user to prevent fraud. The passport size photograph is trimmed and stuck or held in place onto the check or credit card, embossed with the bank's authenticating stamp and laminated with a clear or colored plastic material to prevent tampering.

Although each of the devices and methods in these patents and publications describe new and useful fraud prevention measures, what is needed is a way to protect the issuer and payee of a check in the event that the payee is not physically identifiable. This additional protection can be in the form of a printed instruction to deposit the check only in the account of the payee. Such a check would be well-received in the marketplace and would meet a current demand for such a check, system and method.

### SUMMARY OF THE INVENTION

The invention is a computerized system for producing checks with the payee's picture and identification data, or if no such information is available, printing the instruction “For deposit only: in the account of the payee” on the front of the check. The system includes a server computer, a processor with the server computer, an area of main memory for executing program code under the direction of the processor, a storage device for storing data and program code, a bus connecting the processor and the storage device, at least one database, such as a relational database, stored on the storage device, and computer program code for producing fraud-inhibiting checks stored in the storage device and executing in the main memory under the direction of the processor.

It is a principle object of the invention to provide a fraud-inhibiting check with a payee's picture and identification data printed on the face of the check to allow a recipient of the check to verify the payee's identity.

It is another object of the invention to provide a fraud inhibiting check that also contains important personal identification data.

It is another object of the invention to provide a check with the printed disclaimer “For deposit only: in the account of the payee” where no picture or identification data is available for the payee.

It is a further object of the invention to provide a method of producing fraud-inhibiting checks by entering and storing payee identification data on a database, and printing said data on the check, or if no such information is available, printing the disclaimer “For deposit only: in the account of the payee” on the check.

### BRIEF DESCRIPTION OF THE DRAWINGS

FIG. 1 depicts an overview of a computerized system for producing fraud-inhibiting checks according to the present invention.

FIG. 2 depicts a flowchart showing the method and computerized system of producing fraud-inhibiting checks.

FIG. 3 is the payee input data form used as part of the computerized system for producing fraud-inhibiting checks.

FIG. 4 is an example of a check with payee identification information printed thereon, including a picture of payee, according the method and system for producing fraud-inhibiting checks.

FIG. 5 is an example of a check with a disclaimer according to the method and system for producing fraud-inhibiting checks.

### DETAILED DESCRIPTION OF THE INVENTION

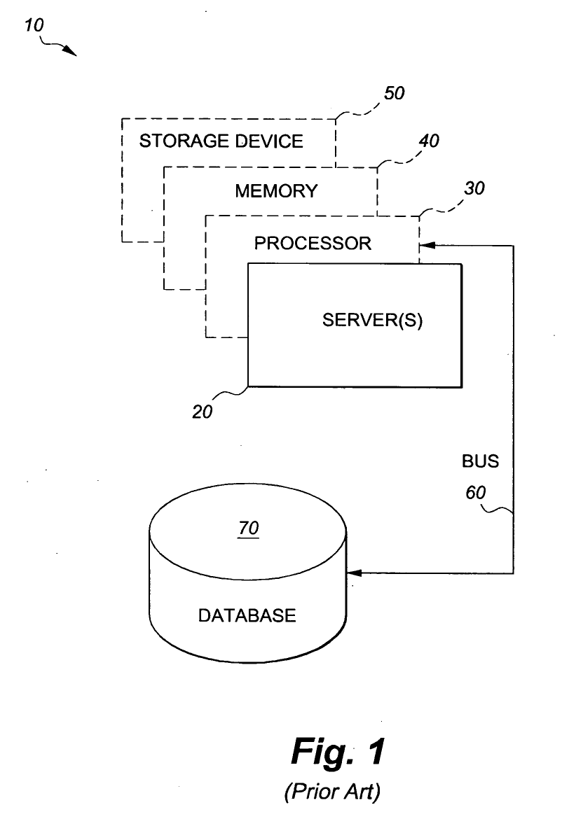

The invention is a computerized system for producing fraud-inhibiting checks 10, as is shown in FIG. 1. The computerized system for producing fraud-inhibiting checks 10 comprises a server computer 20 having a processor 30, an area of main memory 40 for executing program code under the direction of the processor 30, a storage device 50 for storing data and program code, a bus 60 connecting the processor 30 and the storage device 50, at least one database 70 stored on the storage device 50, and computer program code for producing fraud-inhibiting checks stored in the storage device 50 and executing in the main memory 40 under the direction of the processor 30.

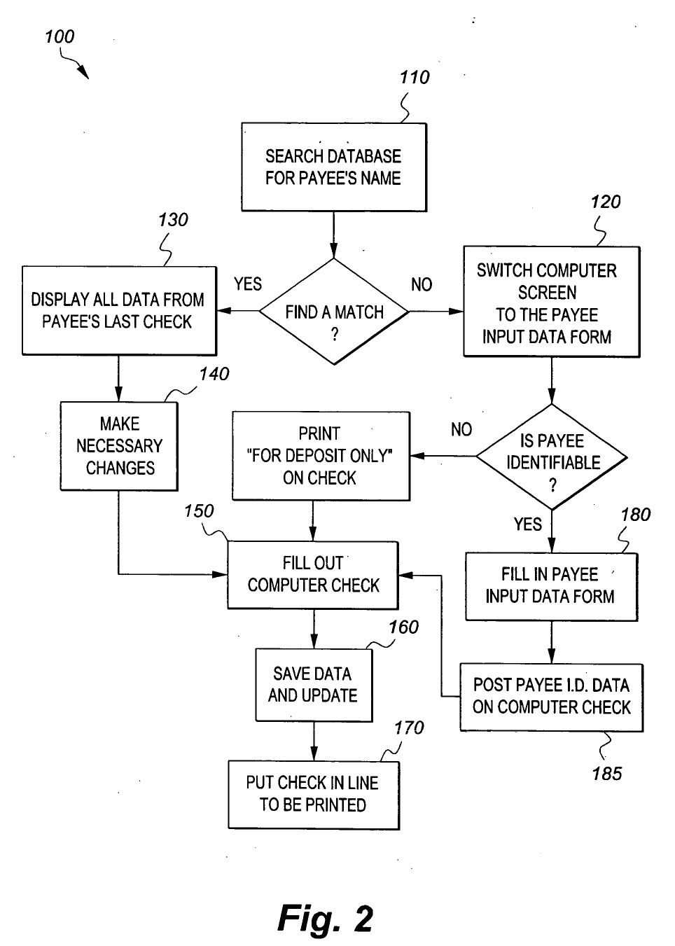

FIG. 2 depicts a decision tree that outlines a method of use of the computerized system for producing fraud-inhibiting checks 100. First, a check issuer will search the database for a payee's name 110. This can be done with any number of search capabilities that are well known in the related art. If the check issuer finds a match, the check issuer can display all data from the payee's last check 130 and make any changes that are necessary 140 to print an accurate new check. Once the changes, if any, have been made, the check issuer can fill out the check details (e.g. the amount) on a computerized representation of the check 150 which may be displayed on a computer screen. The computerized check displays the most recent payee identification data stored in the database. The newly created check 160 can then be stored in the database 70. Once the computer check has been fully filled out, the new check can be printed out 170 and used as desired.

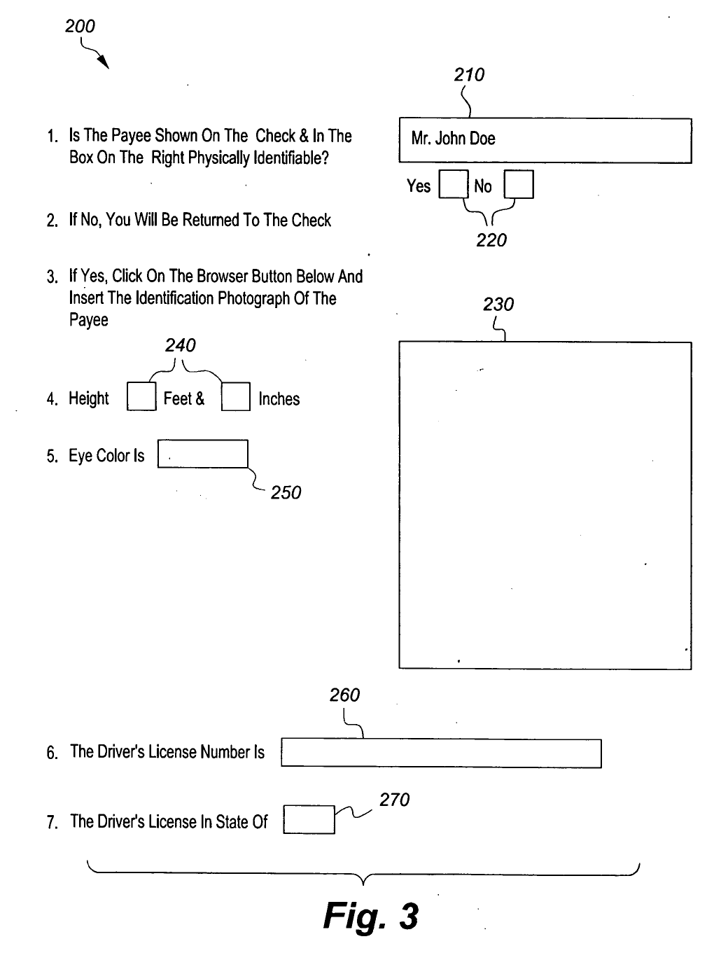

If the check issuer does not find a match, the check issuer can switch to the payee input data form 200 depicted in FIG. 3. The payee input data form 200 is used to enter new payee data into the database. The payee's input data form 200 includes the payee's full name 210, whether the payee is physically identifiable 220, the payee's height 240, the payee's eye color 250, the payee's driver license number 260 and the state of the payee's driver's license 270. It should be understood that the term “payee is not identifiable” refers to whether the payee is satisfactorily identifiable. Specifically, if the payee is not physically identifiable, and in particular if the payee's photo is not available, the payee is regarded as not identifiable. If a digital or scanned photograph is available, the payee's photograph 230 may be uploaded onto the form 200. The technology for uploading, viewing and storing an identification photograph 230 on a computer is well known to those that are schooled in the related art.

If the payee is physically identifiable, the check issuer can simply confirm the payee's approximate height 240, eye color 250 and facial features in comparison to the provided photograph 230. The check issuer can also obtain the payee's driver's license and confirm the payee's driver's license number 260 and state of issue 270. The issuer can also conveniently fill in the payee input data form 200 while gathering data from the payee. The check issuer can also compare the photograph on the payee's driver's license with the photograph provided by the payee. Once the payee input data form 200 has been completed, the check issuer can post the payee data on a computer check 185, fill out the computer check 150, save and update the payee data form 160 and simply print out the new check 170. It should be understood that posting payee data refers to electronically displaying the data on the computer check 150 which may be displayed on the computer screen.

If the payee is not identifiable, no payee input data form 200 will be completed. Instead, the words “For Deposit Only: In The Account Of The Payee” will be printed directly on the check. These words are distinguishable over the related art, in particular U.S. Pat. No. 4,865,351 by Smithson et al., which utilizes the words “Payable only to the party whose photograph and signature appear hereon.” Once the words “For Deposit Only: In The Account Of The Payee” are posted on the electronic check at 150, the check issuer can fill out the check details (e.g. amount) and print out the new check at 170 (see FIG. 2). It should be understood that the words “for deposit only: in the account of the payee” can vary without detracting from the spirit of the instant invention; for example, the phrase “deposit in the account of the payee only.”

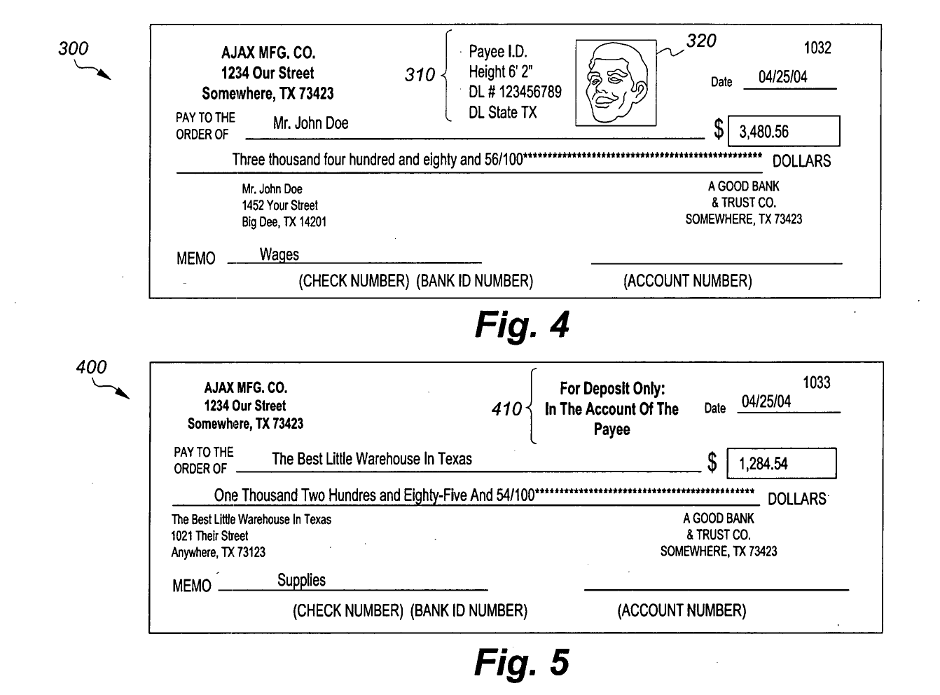

A sample check 300 is depicted on FIG. 4, in which the payee is physically identifiable and the payee input data 310 and photograph of the payee 320 are prominently displayed. Like an ordinary check, the sample check 300 in FIG. 4 has information such as the date, who the check is made out to, who the check is from and a line for a memo. There is also important banking related information such as the check number, the bank identification number and the account number on the sample check 300.

A second sample check 400 is also depicted on FIG. 5. This type of sample check 400 is used when the payee is not identifiable, with the disclaimer “For Deposit Only: In The Account of the Payee” 410 prominently displayed on the check. Like the first sample check 300, the second sample check 400 in FIG. 5 has information such as the date, who the check is made out to, who the check is from and a line for a memo. There is also important banking related information such as the check number, the bank identification number and the account number on the sample check 400.

Use of the computerized system 10 for producing fraud-inhibiting checks is straightforward. The components of the computerized system for producing fraud-inhibiting checks 10 (the server computer 20, processor 30, area of main memory 40, storage device 50, bus 60 and database 70) are all well known to those schooled in the related art. However, the method of use of the computerized system for producing the aforementioned checks 100 is not well known and is used with the computerized system to produce the fraud-inhibiting checks 10 previously described.

It is to be understood that the present invention is not limited to the embodiments described above, but encompasses any and all embodiments within the scope of following claims.

I claim:

1. A computerized system for producing fraud-inhibiting checks, comprising:
a server computer;
a processor with the server computer;
an area of main memory for executing program code under the direction of the processor;
a storage device for storing data and program code;
a bus connecting the processor and the storage device;
at least one database stored on the storage device; and
computer program code for generating fraud-inhibiting checks stored in the storage device and executing in the main memory under the direction of the processor; the computer program including:
means for searching the database for a payee's name;
means for retrieving a payee's input data;
means for confirming the identity of the payee;
means for producing a disclaimer if identity of the payee cannot be confirmed;
means for making any changes and updates to the payee's input data; and
means for producing an accurate and updated check.

2. The system according to claim 1, wherein the payee's input data includes retrieving the payee's full name, the payee's height, the payee's eye color, the payee's driver license number and the state of the payee's driver's license.

3. The system according to claim 1, wherein the database is a relational database.

4. The system according to claim 1, wherein means for confirming the identity of the payee includes physically inspecting the payee and the payee's driver's license and confirming the payee's input data.

5. The system according to claim 1, wherein means for producing a disclaimer involves printing the words “For deposit in the account of the payee” on the payee's check if the payee cannot be physically identified and confirmed.

6. The system according to claim 1, wherein means for producing an accurate and updated check include printing the payee's input data on the check, if the payee is physically confirmed.

7. The system according to claim 1, wherein means for producing an accurate and updated check involves making and printing out a check.

8. A method for producing fraud-inhibiting checks, comprising the steps of:
searching a database for a payee's name;
retrieving a payee's input data;
confirming the identity of the payee;
printing a disclaimer on the check if identity of the payee cannot be confirmed;
making any changes and updates to the payee's input data; and
producing an accurate and updated check.

9. The method according to claim 8, wherein the means for retrieving the payee's input data includes retrieving the payee's full name, the payee's height, the payee's eye color, the payee's driver license number, and the state of the payee's driver's license.

10. The method according to claim 8, wherein means for confirming the identity of the payee includes physically inspecting the payee and the payee's driver's license and confirming the payee's input data.

11. The method according to claim 8, wherein means for producing a disclaimer involves printing the disclaimer “For deposit only: in the account of the payee” on the payee's check if the payee cannot by physically identified and confirmed.

12. The method according to claim 8, wherein means for producing an accurate and updated check include printing the payee's input data on the check, if the payee is physically confirmed.

13. The method according to claim 8, wherein means for producing an accurate and updated check include making and printing out a check.

14. The method according claim 8, wherein the check of a payee who can be physically confirmed displays the payee's input data and a picture of the payee.

15. The check according to claim 14, wherein the check of a payee who cannot be physically confirmed instead displays the disclaimer “For deposit only: in the account of the payee.”
